(19) United States
(12) Patent Application Publication
(10) Pub. No.: US 2004/0240936 A1
(43) Pub. Date: Dec. 2, 2004

(54) Device for locking the final positions of moving switch points

(76) Inventors: Karl Schnedl, Knittelfeld (AT); Herbert Achleitner, Graz (AT); Josef Hortler, Knittelfeld (AT)

Correspondence Address: Robert J Schneider, Chapman & Cutler, 111 West Monroe Street, Chicago, IL, 60603, US

(21) Appl. No.: 10/485,173

(22) PCT Filed: Jul. 31, 2002
(86) PCT No.: PCT/AT02/00226

(30) Foreign Application Priority Data
Aug. 2, 2001 (AT) A 1208/2001

(51) Int. Cl. F16B 2/02; F16B 7/14

(52) U.S. Cl. 403/379.1; 403/350

(57) ABSTRACT

In a device for locking the end positions of movable switch parts and, in particular, movable cross frogs, in which two relatively axially displaceable parts are capable of being displaced into a position coupled with each other in a positive or positive and force-transmitting manner in at least one direction of movement, the relatively displaceable parts are comprised of a tube (2) and a rod (3) guided within the tube (2) and are at least partially arranged in a stationary outer tube (1). The locking members cooperate with the relatively axially displaceable parts (2, 3) and the outer tube (1) and are capable of being displaced in the radial direction into a locking position in a recess or inner annular groove (5) of the outer tube (1). The locking members are formed by rings or ring segments (6) whose substantially square or rectangular cross sections are chamfered on their two inwardly located sides while forming surfaces (9) converging obliquely relative to the axis.

The invention relates to a device for locking the end positions of movable switch parts and, in particular, movable cross frogs, in which two relatively axially displaceable parts are capable of being displaced into a position coupled with each other in a positive or positive and force-transmitting manner in at least one direction of movement, wherein the relatively displaceable parts are comprised of a tube and a rod guided within the tube and are at least partially arranged in a stationary outer tube and the locking members cooperate with the relatively axially displaceable parts and the outer tube and are capable of being displaced in the radial direction into a locking position in a recess or inner annular groove of the outer tube.

From EP-A 603 156 B1, such a device for locking movable switch parts has already become known, in which the relatively displaceable parts are formed by a tube and a pin guided within the tube, and the locking members are designed as balls or rolls capable of being displaced in the radial direction. Departing from such a device, AT 405 925 B proposed to mount the balls in an expandable ring, or ring comprised of segments. The ring or ring segments constituted some kind of ball cage, allowing for the absorption of high locking forces without premature functional impairment. While balls in the idealized form, in principle, provide but a point contact thus causing a relatively high surface pressure, the cage constituted by the ring, or by the ring segments, in the outwardly displaced locking position provides a surface contact, via which high forces can be taken up as locking forces without any premature deformation or destruction. Such a configuration, however, involves the drawback that its assembly is relatively complicated, because the balls have to be held in an appropriate position during installation before being retained in the respective recess by the resilient ring, or the ring segments held together by springs, in a manner immersed in a rod guided within the tube. Enhanced force absorption, however, is only feasible in the locking position in the axial direction, and in the event of high switching forces the risk of damage to the balls as well as the rod via which the ring segments are displaced into their outer locking position continues to exist unchanged.

The invention aims to further develop a device of the initially defined kind to the extent that inadmissible surface pressures in the radial direction, which might lead to plastic deformations, cannot be exceeded, neither during the switching procedure nor in the end positions. Furthermore, the configuration according to the invention aims to facilitate both mounting and dismounting. To solve this object, the configuration according to the invention consists essentially in that the locking members are comprised of rings or ring segments whose substantially square or rectangular cross sections are chamfered on their two inwardly located sides while forming surfaces converging obliquely relative to the axis. By using rings or ring segments bearing at least on their inner sides, on both end sides, surfaces converging obliquely relative to the axis, it can be ensured that during the expansion of the rings or ring segments a surface contact will be safeguarded, via which switching forces or retention forces leading to the expansion or compression of the rings or ring segments can be taken up without any risk of plastic deformation. Thus, plastic deformations are also reliably prevented during the switching procedure by the oblique surfaces acting in the manner of wedge surface to displace the rings into their locking position. At the same time, the number of necessary structural components will be reduced due to the omission of the balls as well as fixing means required for the balls, such as ball cages, clamping pins or the like, and, in the main, a countersink involving a smaller cross sectional loss will be required in the inner tube or rod, respectively, since the rings need no longer immerse into such countersinks with balls arranged therebetween. That reduction of the required countersink in the internally located inner tube or rod results in a substantial increase in the resistance torque, and hence an enhanced strength and wear resistance at reduced structural dimensions. At the same time, this configuration is also applicable for a plurality of locking planes and, in particular, for the displacement of movable cross frogs, with which high switching forces and high locking forces have to be absorbed and locking is required in two different positions each. The stiffness enhanced by the reduced cross sectional weakening and the enhanced resistance torque of the inner tube are of particular relevance in the case of such multiple locking planes.

According to a preferred further development of the device according to the invention, the configuration is devised such that the angle of chamfer (a) of the conically chamfered surfaces amounts to between 20 and 350 relative to the radial central plane of the rings and is formed parallel with oblique abutment surfaces of the rod. Such a choice of the angles of chamfer, or inclination of the oblique surfaces, relative to the radial central plane results in only small frictional forces having to be overcome at relatively small switching forces while maintaining a surface contact, to displace the rings or ring segments into their respective other position. In principle, the inward displacement of the rings or ring segments can be assisted by the use of springs extending about the circumference of the ring segments. Yet, this inward movement can also be initiated by analogous outer chamfers, in which case the configuration is advantageously devised such that the chamfers are provided on the inner and outer circumferences of the rings or ring segments. Additionally, the rings or ring segments can be designed to be expandable against the force of a spring.

In a particularly advantageous manner, the configuration is devised such that the expandable ring is comprised of at least three, preferably four, segments connected by a peripheral tension spring. In principle, it will do in designing rings or ring segments that are outwardly expandable against the force of a spring, to devise the configuration in a manner that the end surfaces extending substantially normal to the locking axis, or the flanks of the chamfered surfaces, are in surface contact with the counter abutment surfaces of the relatively displaceable tubes and/or rods in the respectively outer or inner position of the segments, wherein chamfered surfaces may also be used in the outer position, as already mentioned above.

The optimum surface contact between the ring or ring segments and the rod will be achieved in that the curvature of the inner surfaces of the rings or ring segments corresponds to the curvature of the outer rod diameter. Further improvement will result if, as in correspondence with a preferred further development, the curvature of the outer surfaces of the rings or ring segments corresponds at least partially to the curvature of the inner diameter of the outer tube. By an at least partial adaptation of the curvature of the outer surfaces of the ring segments to the curvature of the inner diameter of the outer tube, any possible line contact will be avoided such that the friction occurring during the switching procedure will be substantially reduced even in the absence of annular springs on account of the uniform surface pressure applied.

In the following, the invention will be explained in more detail by way of an exemplary embodiment schematically illustrated in the drawing. Therein,

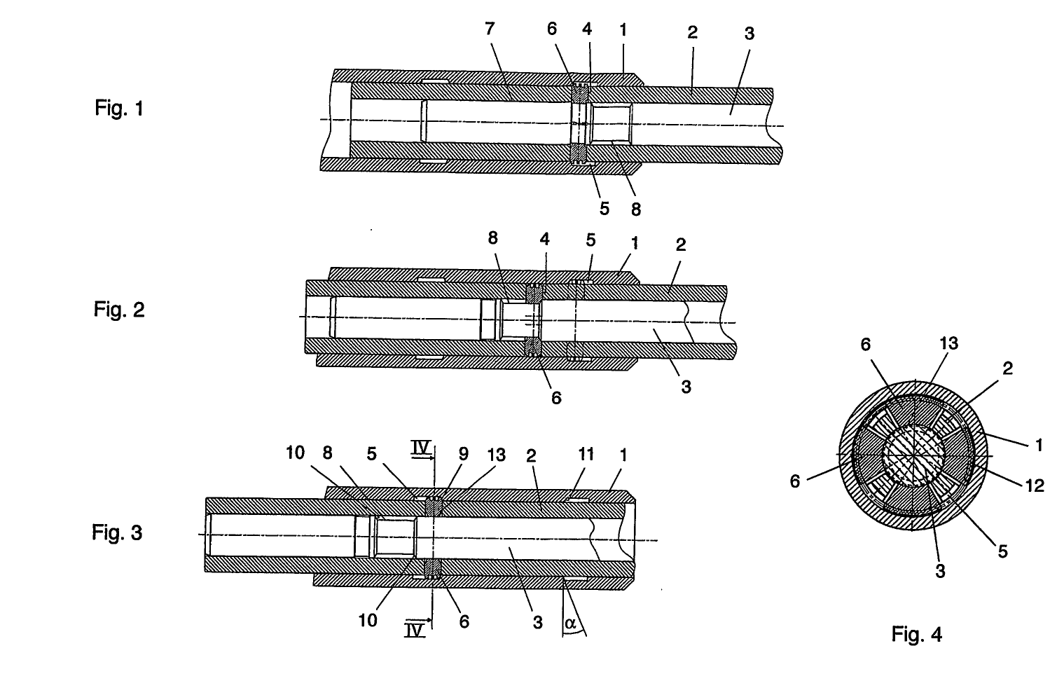

FIG. 1 depicts a first displacement position of rings or ring segments while locking an end position on the right-hand side of the drawing;

FIG. 2 illustrates the configuration according to FIG. 1 during the switching procedure; and

FIG. 3 depicts the locked end position on the left-hand side as required for cross frogs, with

FIG. 4 showing a section along line IV-IV through locking members designed as ring segments.

In FIG. 1, an inner tube 2 and a rod 3 are relatively movably guided within an outer tube 1. The inner tube 2 includes radial openings 4. The outer tube 1 comprises grooves 5 in which rings or ring segments 6 are immersed in the locking position. In the illustration according to FIG. 1, the ring segments 6 are outwardly displaced, ascending on a section 7 formed on the inner rod 3 with an accordingly larger diameter, and thus being displaced outwardly and immersed in a first groove 5 of the outer tube 1.

The rod 3 comprises turned-out regions 8, in which the rings 6 can immerse during the switching procedure, thus getting out of engagement and into a position in which displacement is feasible without locking. This is elucidated in FIG. 2.

In FIG. 3, the displacement of the rod 3 relative to the tube 2 into the second end position is illustrated, with the locking members 6 having been displaced into the respective second groove 5 of the outer tube. The switching procedure and hence the expansion or inward displacement of the ring segments 6 or elastic ring 6, respectively, is feasible via oblique surfaces 9 provided on the end sides of the rings and cooperating with respectively oblique surfaces 10 of the rod and 11, respectively, in the recesses of the outer tube 1. A surface contact is each maintained along these conical chamfered surfaces 9, 10 and 11, respectively, wherein the angle of chamfer α is chosen with a view to readily enabling the respective inward or outward displacement. The rings, if designed as ring segments as illustrated in FIG. 4, can additionally be prestressed in the sense of an inward displacement by tension springs 12 being interposed, the locking position of the ring segments 6 in FIG. 4 being seen to correspond with the position illustrated in FIG. 3, in which the ring segments are outwardly displaced by the rod 3 and pressed into the recesses 5 of the outer tube 1.

In order to substantially reduce the surface pressures in the locked position, the curvature of the inner faces 13 of the rings or ring segments is adapted to the curvature of the outer rod diameter. Existing retention or vibration forces can, thus, be absorbed in a particularly structural-component-saving manner.

1. A device for locking the end positions of movable switch parts, comprising
two relatively axially displaceable parts capable of being displaced into a position coupled with each other in a positive manner in at least one direction of movement, wherein
the relatively displaceable parts comprise a tube (2) and a rod (3) guided within the tube (2) and are at least partially arranged in a stationary outer tube (1), and
locking members cooperate with the relatively axially displaceable parts (2, 3) and the outer tube (1) and are capable of being displaced in the radial direction into a locking position in a recess (5) of the outer tube (1), wherein the locking members of comprise rings or ring segments (6) whose substantially square or rectangular cross sections are chamfered on their two inwardly located sides forming chamfered surfaces (9) converging obliquely relative to an axis of the rod (3).

2. A device according to claim 1, wherein an angle of chamfer (α) of the chamfered surfaces (9) is between 20 and 35° relative to a radial central plane of the rings or ring segments (6) and is formed parallel with oblique abutment surfaces of the rod (3).

3. A device according to claim 1, wherein the chamfered surfaces (9) are provided on inner and outer circumferences of the rings or ring segments (6).

4. A device according to claim 1, wherein the rings or ring segments (6) are designed to be expandable against a force of a spring.

5. A device according to claim 4, wherein the expandable ring comprises at least three segments (6) connected by a peripheral tension spring.

6. A device according to claim 1, wherein end surfaces of the rings or ring segments (6) extending substantially normal to a locking axis are in surface contact with counter abutment surfaces (10) of the relatively displaceable tube (2) or rod (3) in respectively outer or inner position of the rings or ring segments (6).

7. A device according to claim 1, wherein curvature of inner surfaces (13) of the rings or ring segments (6) corresponds to curvature of an outer surface of the rod (3).

8. A device according to claim 1, wherein curvature of outer surfaces of the rings or ring segments (6) corresponds at least partially to curvature of an inner diameter surface of the outer tube (1).

9. A device according to claim 2, wherein the chamfered surfaces (9) are provided on inner and outer circumferences of the rings or ring segments (6).

10. A device according to claim 2, wherein the rings or ring segments (6) are designed to be expandable against a force of a spring.

11. A device according to claim 3, wherein the rings or ring segments (6) are designed to be expandable against a force of a spring.

12. A device according to claim 2, wherein end surfaces of the rings or ring segments (6) extending substantially normal to a locking axis are in surface contact with counter abutment surfaces (10) of the relatively displaceable tube (2) or rod (3) in respectively outer or inner position of the rings or ring segments (6).

13. A device according to claim 3, wherein end surfaces of the rings or ring segments (6) extending substantially normal to a locking axis are in surface contact with counter abutment surfaces (10) of the relatively displaceable tube (2) or rod (3) in respectively outer or inner position of the rings or ring segments (6).

14. A device according to claim 4, wherein end surfaces of the rings or ring segments (6) extending substantially normal to a locking axis are in surface contact with counter abutment surfaces (10) of the relatively displaceable tube (2) or rod (3) in respectively outer or inner position of the rings or ring segments (6).

15. A device according to claim 5, wherein end surfaces of the rings or ring segments (6) extending substantially normal to a locking axis are in surface contact with counter abutment surfaces (10) of the relatively displaceable tube (2) or rod (3) in respectively outer or inner position of the rings or ring segments (6).

16. A device according to claim 2, wherein curvature of inner surfaces (13) of the rings or ring segments (6) corresponds to curvature of an outer surface of the rod (3).

17. A device according to claim 3, wherein curvature of inner surfaces (13) of the rings or ring segments (6) corresponds to curvature of an outer surface of the rod (3).

18. A device according to claim 4, wherein curvature of inner surfaces (13) of the rings or ring segments (6) corresponds to curvature of an outer surface of the rod (3).

19. A device according to claim 5, wherein curvature of inner surfaces (13) of the rings or ring segments (6) corresponds to curvature of an outer surface of the rod (3).

20. A device according to claim 6, wherein curvature of inner surfaces (13) of the rings or ring segments (6) corresponds to curvature of an outer surface of the rod (3).

21. A device according to claim 2, wherein curvature of outer surfaces of the rings or ring segments (6) corresponds at least partially to curvature of an inner surface of the outer tube (1).

22. A device according to claim 3, wherein curvature of outer surfaces of the rings or ring segments (6) corresponds at least partially to curvature of an inner surface of the outer tube (1).

23. A device according to claim 4, wherein curvature of outer surfaces of the rings or ring segments (6) corresponds at least partially to curvature of an inner surface of the outer tube (1).

24. A device according to claim 5, wherein curvature of outer surfaces of the rings or ring segments (6) corresponds at least partially to curvature of an inner surface of the outer tube (1).

25. A device according to claim 6, wherein curvature of outer surfaces of the rings or ring segments (6) corresponds at least partially to curvature of an inner surface of the outer tube (1).

26. A device according to claim 7, wherein curvature of outer surfaces of the rings or ring segments (6) corresponds at least partially to curvature of an inner surface of the outer tube (1).

27. A device according to claim 1, wherein the movable switch parts are movable cross frogs.

28. A device according to claim 1, wherein the two relatively axially displaceable parts capable of being displaced into a position coupled with each other are coupled in a positive and force-transmitting manner in at least one direction of movement.

29. A device according to claim 1, wherein the recess (5) is an inner annular groove of the outer tube (1).
